(19) United States
(12) Patent Application Publication
(10) Pub. No.: US 2006/0085853 A1
(43) Pub. Date: Apr. 20, 2006

(54) System and method for managing the execution of unauthorized programs on a university computer network

(76) Inventor: William F. Simpson, Lawrence, KS (US)

Correspondence Address: HOVEY WILLIAMS LLP, Suite 400, 2405 Grand, Kansas City, MO, 64108, US

(21) Appl. No.: 11/123,717

(22) Filed: May 6, 2005

Related U.S. Application Data
(60) Provisional application No. 60/619,207, filed on Oct. 15, 2004.

(51) Int. Cl. G06F 12/14

(52) U.S. Cl. 726/22

(57) ABSTRACT

A computer program directs a network server computer to maintain a program control list and to allow a user to update the program control list. The program directs a client computer to request the list of prohibited programs, to monitor programs running on the client computer, and to terminate any prohibited programs by invoking an application program interface (API) method. The client computer may use one or more of three API methods, including the SendMessage, CreateRemoteThread, and TerminateProcess Win32 API methods.

### RELATED APPLICATION

The present application is a nonprovisional patent application and claims priority benefit, with regard to all common subject matter, of earlier-filed U.S. provisional patent application titled “STRATEGIES FOR MANAGING THE EXECUTION OF UNAUTHORIZED PROGRAMS ON A UNIVERSITY COMPUTER NETWORK”, Ser. No. 60/619,207, filed Oct. 15, 2004. The identified earlier-filed application is hereby incorporated by reference into the present application.

### BACKGROUND OF THE INVENTION

1. Field of the Invention

The present invention relates to a system and method for preventing the execution of unauthorized programs on a computer network. More specifically, the invention relates to a computer program that enables a server computer to distribute a list of prohibited programs to a plurality of client computers and enables the client computers to terminate any programs that are included in the list of prohibited programs by invoking an application program interface (API) method.

2. Description of Prior Art

Universities and other organizations that maintain large networks of computers often struggle with the problem of users running unauthorized programs on network client computers. Software relating to Internet telephony, instant messaging, computer games, and file swapping are among the programs installed on such computer networks without the assent and/or knowledge of a network administrator.

Use of such unauthorized programs on the networks can create a number of problems for the host organization, including technical and legal problems. Use of unauthorized programs on computer networks can present maintenance and capacity challenges unanticipated by network administrators. Because network administrators are not aware of the presence of the software, they often are not sufficiently familiar with the software to anticipate or quickly resolve conflicts or other issues that arise when the programs are executed. Furthermore, the unauthorized programs require disk space and network bandwidth to operate. A large number of programs can significantly decrease the amount of disk space and/or network bandwidth available to authorized programs, and thus can inhibit the overall performance of the authorized software. Use of unauthorized programs on the networks can also result in legal problems for the organization if, for example, the programs are used to illegally obtain or distribute computer files or other software, or if the programs are illegally copied in violation of copyright laws.

One method of preventing users from executing unauthorized software on a computer network involves monitoring network client computers either in person or by tracking the software running on each client via a network server and terminating each unauthorized program individually. This method, of course, can be very difficult or impossible to implement if the network includes a large number of client computers. Accordingly, there remains a need for an improved method of preventing users from executing unauthorized programs on a computer network that does not suffer from the above-described problems and limitations.

### SUMMARY OF THE INVENTION

The present invention overcomes the above-described problems and provides a distinct advance in the art of computer network management. More particularly, the present invention provides a computer program that directs a server computer to maintain a list of prohibited programs and communicate the programs to a plurality of network client computers. The program also directs each client computer to monitor programs running thereon and to terminate any prohibited programs by invoking an application program interface (API) method.

In one embodiment, the invention includes a computer-readable medium encoded with a computer program for enabling a computer to manage the execution of unauthorized programs on a computer system. The computer program includes code segments for enabling a server computer to receive and store a program control list; for enabling a client computer to request the program control list from the server computer when a user logs into the client computer; for enabling the client computer to compare a program running on the client computer with a program included in the program control list; and for enabling the client computer to terminate the program running on the client computer if it matches the program included in the program control list.

In another embodiment, the computer program includes code segments for enabling an FTP server to receive and store a list of prohibited programs and for enabling the FTP server to allow a user to update the list of prohibited programs only if the user submits a valid username and password. The program further enables the client computer to request the list of prohibited programs from the server computer when a user logs into the client computer, and to request the list of prohibited programs from the server computer periodically while the user is logged into the client computer.

The program further enables the client computer to create a list of computer programs running on the client computer, and to compare each program from the list of programs running on the client computer to each program in the list of prohibited programs. Finally, the program enables the client computer to terminate each computer program running on the client computer that matches an entry in the list of prohibited computer programs by invoking an API method, and to generate a user message to inform the user that the computer program was terminated due to a security violation.

In another embodiment, the invention involves a method of using a computer to manage the execution of unauthorized programs on a computer system. The method includes the steps of installing a program control list on an FTP server, wherein the control list includes names of prohibited programs, and installing a security program on a client computer as a system service, wherein the security program reads the program control list, monitors programs running on the client computer, terminates any programs running on the client computer that are included in the program control list by invoking an API method, and communicates an error message to a user relating to the terminated program. The client computer is configured so that the security program is executed when a user logs into the client computer, and the security program is assigned a high priority so that it has a higher priority than other applications. Finally, the program control list is updated on the FTP server by adding names of additional prohibited programs, and the program control list is updated on the FTP server by removing names of prohibited programs.

These and other important features of the present invention are more fully described in the section titled DETAILED DESCRIPTION OF PREFERRED EMBODIMENTS, below.

### BRIEF DESCRIPTION OF THE DRAWINGS

A preferred embodiment of the present invention is described in detail below with reference to the attached drawing figures, wherein:

FIG. 1 is a computer network for implementing a computer program for managing the execution of unauthorized programs according to a preferred embodiment of the present invention;

FIG. 2 is a flowchart of steps involved in a computer program for managing the execution of unauthorized programs on the computer network of FIG. 1;

FIG. 3 is a flowchart of steps involved in invoking a GetWindowText API method to terminate a prohibited program as part of the computer program of FIG. 2; and

FIG. 4 is a flowchart of steps involved in invoking a CreateRemoteThread API method to terminate a prohibited program as part of the computer program of FIG. 2.

### DETAILED DESCRIPTION OF PREFERRED EMBODIMENTS

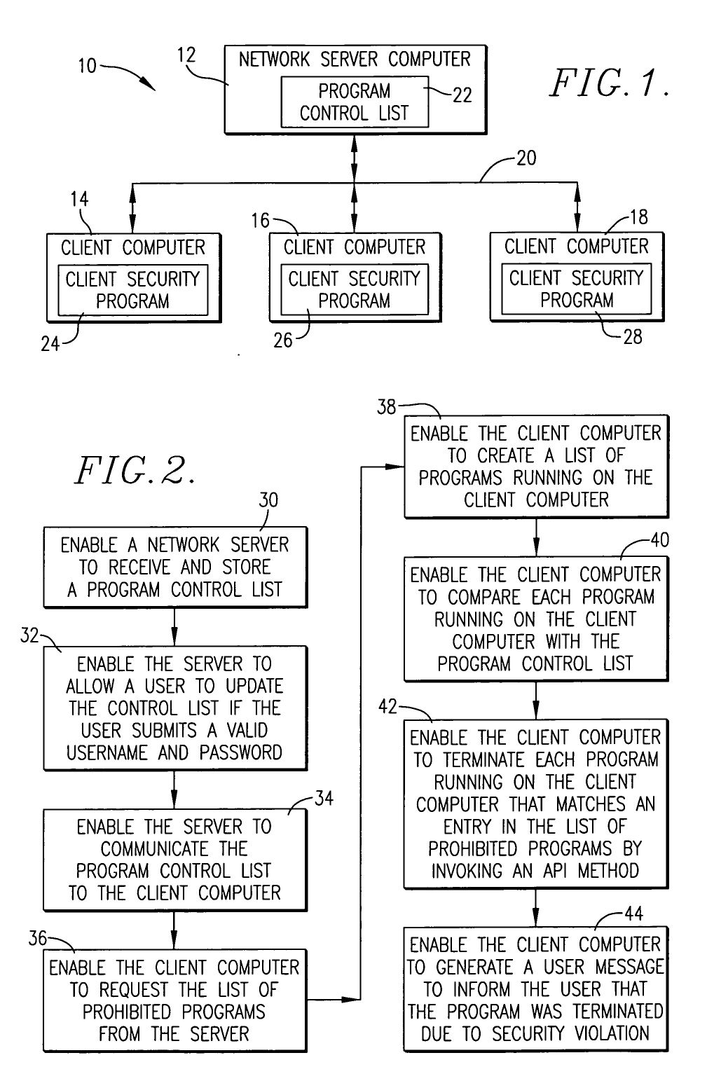

Referring initially to FIG. 1, an exemplary computer network employing the principles of the present invention is shown and designated generally by the reference numeral 10. The computer network 10 includes a network server computer 12 and a plurality of network client computers 14,16,18 interconnected via a network communications path 20. The server computer 12 stores a program control list 22, while the client computers 14,16,18 each include an executable client security program 24,26,28. Generally, each client security program 24,26,28 monitors programs running on its respective client computer 14,16,18 and terminates any programs that are included in the program control list 22.

The network server computer 12 manages network activities and preferably employs the file transfer protocol (FTP) to exchange files with the client computers 14,16,18 via the network communications path 20. Itwill be appreciated that the network server computer 12 may be of any type known in the art and may communicate with the client computers 14,16,18 via any of various communications protocols. Each of the client computers 14,16,18 are virtually identically configured, therefore only client computer 14 and its interactions with the network server computer 12 will be described in detail with the understanding that client computers 16 and 18 are similar in function.

Referring also to FIG. 2, an exemplary method of managing the execution of unauthorized programs on the computer network 10 employing the principles of the present invention is shown. The method of FIG. 2 is preferably implemented on the computer network 10 as computer software encoded on a computer-readable medium. Computer-readable media is a broad class of media operable to store and/or communicate instructions to a computer including, for example, magnetic media such as hard drives and floppy disks; optical data storage devices such as CDs and DVDs; solid state data storage devices such as FLASH™ memory; and data communication media including wireless and wired data communication paths.

While all computer-readable instructions necessary to implement the present invention are hereinafter collectively referred to as “the computer program” or simply “the program,” it will be appreciated that the program may be divided into distinct code segments or sub-programs stored on separate computer-readable media. The client security programs 24,26,28, for example, are each preferably stored locally on the client computers 14,16,18, respectively, while a code segment for enabling or enabling the network server computer 12 to manage the program control list 22 is preferably stored locally on the network server computer 12. Alternately, one or more segments of the computer program may be stored remotely from the client computers 14,16,18 and/or the network server computer 12 and communicated to the target computer immediately prior to execution.

The program first enables or directs the network server computer 12 to receive and store the control list 22, as depicted in block 30. The control list 22 includes a list of prohibited programs, such as programs involving Internet telephony, instant messaging, file swapping, computer games, and other programs commonly installed on computer networks by students and other users without permission from the organization, entity, or person hosting the network. The network server computer 12 receives the program control list 22 from a user, such as a network administrator, via an input mechanism local to the server computer 12 such as a floppy disk drive, keyboard or other user interface, CD-ROM drive, or USB FLASH≯ drive. Alternatively, the server computer 12 may receive the program control list 22 from another computer via network communications, such as from a remote network computer through Internet communications. Enabling the server computer 12 to receive the program control list 22 from a remote computer enables a user to implement the present invention on various geographically remote computer networks and provide a single program control list for use with all of the networks.

The program enables the network server computer 12 to store the program control list 22 so that the client computer 14 can access the list 22. The list 22 may thus be stored locally on the network server computer 12, or may be stored on a remote computer. If the list 22 is stored on a remote computer, the client computer 14 would request the list 22 from the network server computer 12, which would in turn request the list 22 from the remote computer on which the list 22 resides. The program enables the server computer 12 to allow a user to update the program control list 22, as depicted in block 32, and enables the server computer 12 to implement security measures so that only an authorized user may access and modify the list 12. In the preferred embodiment, the server computer 12 only allows access to the program control list 22 if the user submits a valid username and password.

Allowing a user to access and modify the program control list 22 enables the user to quickly update the entire computer network 10. The user, such as a network administrator, could quickly add a prohibited program to the program control list 22, which would be disseminated to the client computers 14,16,18 instantaneously, or nearly instantaneously, as the server computer 12 initiates a transfer of the list 22 to the client computer 14 as depicted in block 34.

In addition to enabling the server computer 12 to initiate a transfer of the list 22 to the client computer 14, the program enables the client computer 14 to request the list 22 from the server computer 12, as depicted in block 36. This function is preferably performed by the client security program 24 each time a user logs into the client computer 14 to ensure that the client computer 14 has a fresh copy of the list 22. The client security program 24 also preferably enables the client computer 14 to request the list 22 periodically while a user is logged on, to ensure that any updates made to the list 22 will be reflected in the operation of the program.

The program enables the client computer 14 to create a list of programs running on the client computer 14, as depicted in block 38. As explained below in greater detail, the client computer 14 may use one or more application programming interface (API) methods to retrieve handles of programs running on the client computer. Once the client computer 14 has created the list of programs running on the client computer, the client security program 24 enables the client computer 14 to compare each program running on the client computer with the program control list 22, as depicted in block 40. It may do this, for example, by simply reading the list of programs running on the client computer, one entry at a time, and comparing each entry with each entry in the program control list 22.

The client security program 24 enables the client computer 14 to terminate each program running on the client computer 14 that matches an entry of the list of prohibited programs in the program control list 22, as depicted in block 42. The client computer 14 preferably terminates the programs by invoking one of three API methods: “SendMessage,” “CreateRemoteThread,” or “Terminate process.” The steps involved in using each API method to terminate the program is discussed below in detail. Furthermore, exemplary computer code for implementing each method is listed in related provisional application “STRATEGIES FOR MANAGING THE EXECUTION OF UNAUTHORIZED PROGRAMS ON A UNIVERSITY COMPUTER NETWORK,” Ser. No. 60/619,207, filed Oct. 15, 2004 and incorporated into the present application by reference.

### SendMessage API Method

The preferred method of terminating a WINDOWS™ program running on the client computer 14 is by invoking the SendMessage API method to send the program a WM_CLOSE message. Using this method, the prohibited program is closed “cleanly” in that the program is terminated along with any associated subsidiary programs and dynamically loaded libraries (DLLs). A preferred implementation of the SendMessage API method is illustrated in FIG. 3. In the preferred implementation, the client security program 24 includes one or more code segments that enable the client computer 14 to retrieve and store a handle associated with each window running on the client computer, as depicted in block 46.

Window handles are used by the operating system to identify and manipulate a window associated with each program running on the system. The security program 24 enables the client computer 14 to use the API method GetWindowText to extract a text string from each handle, wherein the text string includes the name of the program associated with the window handle, as depicted in block 48. The security program 24 then enables the client computer 14 to tokenize the text string and parse the tokens to extract a name of the program associated with the handle, as depicted in block 50. The security program 24 then enables the computer 14 to compare the name of the program associated with the handle to each program name in the list of prohibited programs to determine if the program associated with the handle is prohibited, as depicted in block 52. If the program associated with the handle matches a name on the list of prohibited programs, the security program 24 enables the computer 14 to send the prohibited program the WM_CLOSE message to terminate the prohibited program along with any subsidiary programs and DLLs, as depicted in blocks 54 and 56. If the program associated with the handle does not match a name from the list of prohibited programs the security program 24 enables the computer 14 to allow the program associated with the handle to continue running, as depicted in block 58, and to retrieve a name of another program running on the client computer to continue the process of comparing programs running on the client computer 14 to the list of prohibited programs.

Invoking the SendMessage API method has the additional benefit of preventing web browsers from accessing particular web pages. When a web browser loads and displays a web page, the task name of the browser registered with the system includes a name associated with the web page, such as, for example, YAHOO™. Thus, if the name of a web page is included in the list of prohibited programs, a web browser program that has loaded the page will be terminated because it will match a name on the list of prohibited programs.

### CreateRemoteThread API Method

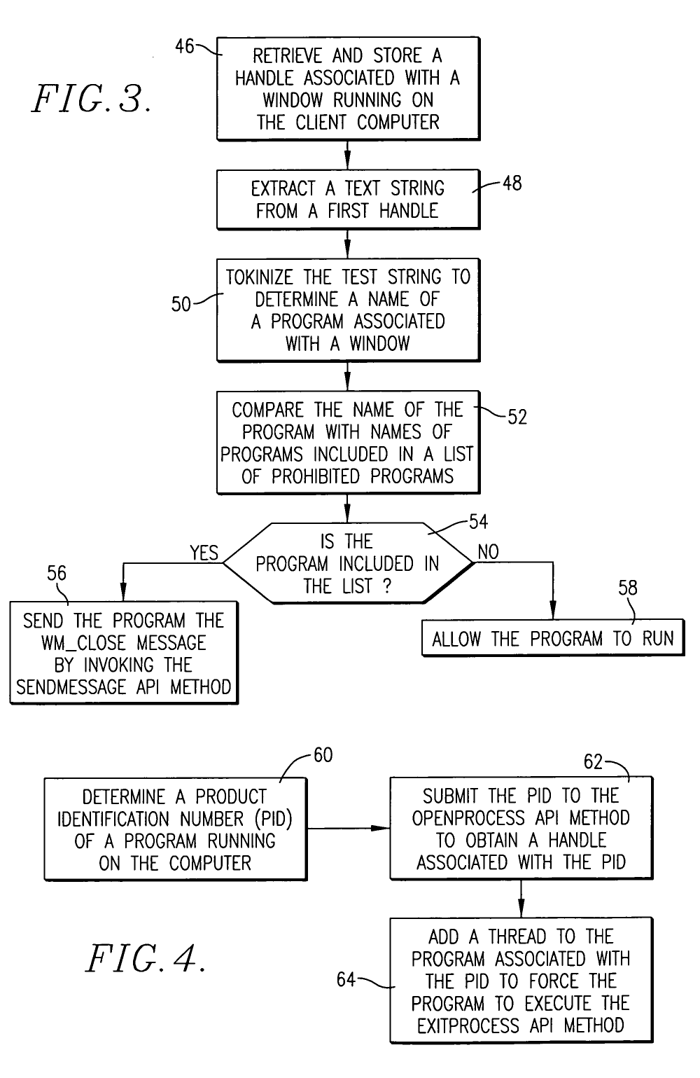

In an alternative embodiment of the present invention, the client security program 24 enables the client computer 14 to use the CreateRemoteThread API method to terminate a prohibited program. A preferred implementation of the CreateRemoteThread API method is illustrated in FIG. 4. The security program 24 first enables the computer 14 to determine the product identification (PID) number for a program that is running on the client, as depicted in block 60. The security program 24 enables the computer 14 to submit each PID to the OpenProcess API method, which returns the handle of the window associated with the PID, as depicted in block 62. The security program 24 then enables the computer 14 to add a thread to the program associated with the PID, wherein the thread forces the program to execute the ExitProcess API method to cause the target process to terminate in an orderly manner, as depicted in block 64. Invoking the CreateRemoteThread also closes the target program in a “clean” manner by properly releasing all subsidiary processes and DLLs.

### TerminateProcess API Method

The TerminateProcess API method provides a very simple way to terminate a program from within another program in the WINDOWS™ operating system. The client computer 14 simply submits the product identification (PID) number of the program to terminate and a return code. While the TerminateProcess API method provides a simple procedure for terminating a program running on the client computer 14, it only terminates the target program and allows DLLs and subsidiary processes to remain running.

Each time the client security program 24 enables the client computer 14 to terminate a program, it also enables the client computer 14 to generate an error message, as depicted in block 44. The error message is presented for a user of the client computer 14 and informs the user that the program was terminated due to a security violation. Informing the user of the reason for terminating the program helps avoid the problems of a user repeatedly attempting to run the program on the client computer 14 and users contacting a network administrator to determine why the program was terminated.

The client security program 24 is preferably designed to run on the client computer 14 as a system service to make it more difficult to attach. The client security program 24 is further preferably configured to begin running each time a user logs into the client computer 14. This may be done, for example, by including the program as an event in a policy schedule corresponding to a user login. Finally, the client security program 24 should be assigned an above normal or high priority so that it has a higher priority than other programs.

Although the invention has been described with reference to the preferred embodiments illustrated in the attached drawings, it is noted that equivalents may be employed and substitutions made herein without departing from the scope of the invention as recited in the claims. It will be appreciated, for example, that the system and method of the present invention is not limited to preventing the execution of unauthorized programs on the network but may also limit use of certain programs by maintaining a list of which users are authorized to execute certain programs and permitting those programs to be executed on a client computer only if an authorized user is logged into the client computer.

Having thus described the preferred embodiment of the invention, what is claimed as new and desired to be protected by Letters Patent includes the following:

1. A computer-readable medium encoded with a computer program for directing a computer to manage the execution of unauthorized programs on a network computer system, the computer program including code segments for:
(a) enabling a server computer to receive and store a program control list;
(b) enabling a client computer to request the program control list from the server computer when a user logs into the client computer;
(c) enabling the client computer to compare a program running on the client computer with a program included in the program control list; and
(d) enabling the client computer to terminate the program running on the client computer if it matches the program included in the program control list.

2. The computer-readable medium as set forth in claim 1, the computer program further including a code segment for:
(e) enabling the client computer to terminate the program running on the client computer by invoking an API method if the program matches the program included in the program control list.

3. The computer-readable medium as set forth in claim 1, the computer program further including a code segment for:
(f) enabling the client computer to terminate the program running on the client computer by invoking the TerminateProcess method of the Win32 API if the program matches the program included in the program control list.

4. The computer-readable medium as set forth in claim 1, the computer program further including a code segment for:
(g) enabling the client computer to terminate the program running on the client computer by invoking the SendMessage method of the Win32 API to send the application a WM_CLOSE message if the program matches the program included in the program control list.

5. The computer-readable medium as set forth in claim 4, the computer program further including a code segment for:
(h) obtaining a window handle of the program running on the client computer.

6. The computer-readable medium as set forth in claim 5, the computer program further including a code segment for:
(i) invoking the GetWindowText method of the Win32 API to extract a text string from the handle, wherein the text string is related to the handle.

7. The computer-readable medium as set forth in claim 6, the computer program further including a code segment for:
(j) parsing the text string to extract a name of the program running on the client computer.

8. The computer-readable medium as set forth in claim 7, the computer program further including a code segment for:
(k) comparing the name of the program running on the client computer with a name of the program included in the program control list, and directing the client computer to terminate the program running on the client computer if the name of the program running on the client computer matches the name of the program included in the program control list.

9. The computer-readable medium as set forth in claim 1, the computer program further including a code segment for:
(l) enabling the client computer to terminate the program running on the client computer by invoking the CreateRemoteThread of the Win32 API if the program matches the program included in the program control list.

10. The computer-readable medium as set forth in claim 9, the computer program further including a code segment for:
(m) determining a product identification number of the program running on the client computer.

11. The computer-readable medium as set forth in claim 10, the computer program further including a code segment for:
(n) obtaining a window handle of the program running on the client computer by submitting the product identification number to the OpenProcess method of the Win32 API.

12. The computer-readable medium as set forth in claim 11, the computer program further including a code segment for:
(o) adding a thread to the program running on the client computer, wherein the thread causes the program to execute the ExitProcess method of the Win32 API.

13. The computer-readable medium as set forth in claim 1, the computer program further including a code segment for:
(p) enabling the server computer to receive the program control list from a remote computer via a network communications path.

14. The computer-readable medium as set forth in claim 1, the computer program further including a code segment for:
(q) enabling the server computer to initiate a communication of the program control list to the client computer.

15. The computer-readable medium as set forth in claim 1, the computer program further including a code segment for:
(r) enabling the client computer to request the program control list from the server computer at the time a user logs into the client computer, and to request the program control list from the server computer periodically while the user is logged onto the client computer.

16. A computer readable medium encoded with a computer program for directing a computer to manage the execution of unauthorized programs on a network computer system, the computer program including code segments for:
(a) enabling an FTP server to receive and store a list of prohibited programs;
(b) enabling the FTP server to allow a user to update the list of prohibited programs only if the user submits a valid username and password;
(c) enabling the client computer to request the list of prohibited programs from the server computer when a user logs into the client computer;
(d) enabling the client computer to request the list of prohibited programs from the server computer periodically while the user is logged into the client computer;
(e) enabling the client computer to create a list of computer programs running on the client computer;
(f) enabling the client computer to compare each program from the list of programs running on the client computer to each program in the list of prohibited programs;
(g) enabling the client computer to terminate each computer program running on the client computer that matches an entry in the list of prohibited computer programs by invoking an API method; and
(h) enabling the client computer to generate a user message to inform the user that the computer program was terminated due to a security violation.

17. The computer-readable medium as set forth in claim 16, the computer program further including a code segment for:
(i) enabling the client computer to terminate each computer program running on the client computer that matches an entry in the list of prohibited programs by invoking the CreateRemoteThread of the Win32 API.

18. The computer readable medium as set forth in claim 16, the computer program further including a code segment for:
(j) enabling the client computer to terminate each computer program running on the client computer that matches an entry in the list of prohibited programs by invoking the SendMessage method of the Win32 API to send the application a WM_CLOSE message.

19. The computer-readable medium as set forth in claim 18, the computer program further including a code segment for:
(k) obtaining a window handle of the program running on the client computer.

20. The computer-readable medium as set forth in claim 19, the computer program further including a code segment for:
(l) invoking the GetWindowText method of the Win32 API to extract a text string from the handle, wherein the text string is related to the handle.

21. The computer-readable medium as set forth in claim 20, the computer program further including a code segment for:
(m) parsing the text string to extract a name of the program running on the client computer.

22. The computer-readable medium as set forth in claim 21, the computer program further including a code segment for:
(n) comparing the name of the program running on the client computer with a name of the program included in the program control list, and directing the client computer to terminate the program running on the client computer if the name of the program running on the client computer matches the name of the program included in the program control list.

23. The computer readable medium as set forth in claim 16, the computer program further including a code segment for:
(o) enabling the client computer to terminate each computer program running on the client computer that matches an entry in the list of prohibited programs by invoking the CreateRemoteThread method of the Win32 API.

24. The computer-readable medium as set forth in claim 23, the computer program further including a code segment for:
(p) determining a product identification number of the program running on the client computer.

25. The computer-readable medium as set forth in claim 24, the computer program further including a code segment for:
(q) obtaining a window handle of the program running on the client computer by submitting the product identification number to the OpenProcess method of the Win32 API.

26. The computer-readable medium as set forth in claim 25, the computer program further including a code segment for:
(r) adding a thread to the program running on the client computer, wherein the thread causes the program to execute the ExitProcess method of the Win32 API.

27. A method of using a computer to manage the execution of unauthorized programs on a network computer system, the method comprising the steps of:
(a) installing a program control list on an FTP server, wherein the control list includes names of prohibited programs;
(b) installing a security program on a client computer as a system service, wherein the security program reads the program control list, monitors programs running on the client computer, terminates any programs running on the client computer that are included in the program control list by invoking an API method, and communicates an error message to a user relating to the terminated program;
(c) configuring the client computer so that the security program is executed when a user logs into the client computer;
(d) assigning the security program a high priority so that it has a higher priority than other applications;
(e) updating the program control list on the FTP server by adding names of additional prohibited programs; and
(f) updating the program control list on the FTP server by removing names of prohibited programs.
